(19) United States
(12) Patent Application Publication
(10) Pub. No.: US 2026/0201988 A1
(43) Pub. Date: Jul. 16, 2026

(54) CLAMP WITH HINGE HAVING LIMITED OPENING ANGLE

(71) Applicant: Oetiker Schweiz AG, Horgen (CH)

(72) Inventors: Kamil GORA, Legnickie (PL); Arkadiusz LUPIERZ, Legnickie (PL)

(73) Assignee: Oetiker Schweiz AG, Horgen (CH)

(21) Appl. No.: 19/127,805

(22) PCT Filed: Nov. 15, 2023
(86) PCT No.: PCT/EP2023/081970

§ 371 Date: May 7, 2025

(30) Foreign Application Priority Data
Nov. 22, 2022 (DE) 10 2022 130 925.8

(51) Int. Cl. F16L 23/04

(52) U.S. Cl. CPC F16L 23/04

(57) ABSTRACT

The invention relates to a clamp comprising a clamping band (10), a tensioning element (12) for tensioning the clamping band (10) and a hinge (14) provided at a position opposite to the tensioning element (12), wherein the hinge (14) connects the ends of two essentially semi-circular halves (10a, 10b) of the clamping band (10) in a pivotable manner, wherein the hinge (14) includes a trunnion (16) arranged in an axial direction of the clamp.

It is proposed that the ends of the two essentially semi-circular halves (10a, 10b) of the clamp are formed so as to include at least one flat band loop (14a-14c), respectively, wherein an inner surface of the flat band loops (14a-14c) bears on a cylindrical outer surface (24g) of the trunnion (16).

### FILED OF THE INVENTION

The invention relates to a clamp comprising a clamping band, a tensioning element for tensioning the clamping band and a hinge.

### BACKGROUND OF THE INVENTION

The document FR587221A discloses a band clamp with a tensioning element and a hinge. A trunnion or pin of the hinge engages with axial bores in tabs protruding radially from the outer surface of band. The clamping force is therefore transmitted via the narrow inner circumference o the bores in the tabs. A similar hinge element is disclosed in CA 2705188 A1.

The hinge elements as disclosed in FR587221A or CA 2705188 A1 risk to be deformed upon applying large tensioning forces.

The invention seeks to solve the problem of providing a band clamp with a hinge wherein the transmission of the tensioning force via the hinge is improved. Further aspects of the invention relate to means facilitating the mounting of the clamp.

The invention proposes to solve the above problem by providing a clamp according to claim 1. Further advantageous embodiments of the invention are defined in the dependent claims.

The invention relates to a clamp comprising a clamping band, a tensioning element for tensioning the clamping band and a hinge provided at a position opposite to the tensioning element, wherein the hinge connects the ends of two essentially semi-circular halves of the clamping band in a pivotable manner, wherein the hinge includes a trunnion arranged in an axial direction of the clamp.

It is proposed that the ends of the two essentially semi-circular halves of the clamp are formed so as to include at least one flat band loop, respectively, wherein an inner surface of the flat band loops bears on a cylindrical outer surface of the trunnion. The force transmission via flat band loops is more reliable and the hinge element is less likely to be deformed than in the prior art, even when large tensioning forces are applied.

A band in the sense of the present specification is a strip, in particular a rolled sheet metal strip with an essentially rectangular profile having a larger width than thickness, in particular with an aspect ratio larger than 3, preferably larger than 5. A flat band loop may be a loop formed out of a band by folding back the broader side of the band onto itself, i.e. such that shape of the band remains flat in the width direction or, in an alternative embodiment, a loop made from a separate band and welded or otherwise fixed onto the main body of the band.

The trunnion may be a solid body, a hollow body such as a tube-shaped element or may be integrally formed as a part of one of the band halves.

In a particularly advantageous embodiment of the invention, the clamp includes at least one section provided with an inlay of generally V-shape cross-section configured to interact with flanges formed at mutually facing ends of two pipes to be interconnected. The inlay can alleviate the local pressure peaks caused by the trunnion of the hinge and eventual further trunnions of the tensioning element. Moreover, the advantages of the invention can fully play out in this application because clamps with V-shaped inlay are often used in applications with high tensioning forces. The inlay can be divided in multiple sections, in particular one section for each of the two halves of the band, preferably two sections for each of the halves of the band, i.e. a total of four sections of the inlay with V-shape cross-section.

In a preferred embodiment of the invention, the hinge includes limiting means for limiting the pivot angle to less than 180°, more preferable to limit the pivot angle to less than 120°, even more preferable to limit the pivot angle to 100° or less. In a preferred embodiment of the invention, the limit angle is adjustable, either by adjusting one element of the hinge or by selecting a suitable trunnion as explained in further detail below.

The skilled person will understand that the limiting means according to the invention is not necessarily a hard stop. For the purpose of avoiding unintended free dangling of the movable half of the clamp in the course of the assembly procedure, it is sufficient that a soft stop is provided, which may be overcome by applying a certain threshold force, which should be larger than the typical weight- and acceleration forces acting on the hinge in the course of regular assembly.

It is further proposed that the limiting means is formed by at least one protrusion on an inner surface of the flat band loops engaging with a recess on the cylindrical outer surface of the trunnion, wherein a circumferential length of the recess is configured to limit the pivot angle. The protrusions can be easily formed by embossing the band and the circumferential length is easily adaptable to set the pivot angle.

In a preferred embodiment of the invention, each of the flat band loops includes a protrusion engaging with a corresponding recess on the cylindrical outer surface of the trunnion.

A reliable and balanced force transmission can be achieved if a first one of the semi-circular halves of the clamp includes two flat band loops with a gap in between and the second one of the semi-circular halves of the clamp includes at least one flat band loop engaging in the gap between the two flat band loops of the first semi-circular half of the clamp. This fork-shaped design of flat-band trunnion hinges has proven reliable in other applications of hinges.

In a further embodiment of the invention, the limiting means is formed by a web connecting the two flat band loops of the first one of the semi-circular halves of the clamp, wherein the flat band loop of the second one of the semi-circular halves of the clamp abuts upon the web upon reaching the limit value of the pivot angle. The provision of the web is a simple way of limiting the opening angle.

In a preferred embodiment, a shape and/or position of the web is adjustable to thereby adjust the limit value of the pivot angle.

### BRIEF DESCRIPTION OF THE DRAWINGS

Embodiments of the invention will be described below in more detail with reference to the drawings, in which:

FIG. 1 is a band clamp according to a first embodiment of the invention;

FIG. 2A illustrates a pivoting movement for closing a band clamp with a hinge according to the prior art;

FIG. 2B illustrates the limited pivot angle of band clamp according to the invention;

FIG. 3A illustrates a typical assembly situation for a generic band clamp with a hinge;

FIG. 3B illustrates the assembly situation of FIG. 2a when using a band clamp according to the invention;

FIG. 4 is a detail view of the hinge of the band clamp according to the invention;

FIG. 5 is a detail view of the trunnion of the band clamp according to FIGS. 1 and 3;

FIG. 6 is a band clamp according to a second embodiment of the invention with a displaceable web;

FIG. 7 is a band clamp according to a third embodiment the invention with a fixed web;

FIG. 8 is a sectional view of a hinge of the third embodiment of the invention;

FIG. 9 is a schematic illustration showing limit angles of the hinge of the third embodiment of the invention;

FIG. 10 is a band clamp according to a fourth embodiment the invention with a fixed web with a limiting means constituted by a rear edge of a gap, wherein the rear edge of the gap is positioned to abut to the at least one flat band loop (14c) of second one of the semi-circular halves (10b) to form said limiting means.

### DETAILED DESCRIPTION OF EMBODIMENTS OF THE INVENTION

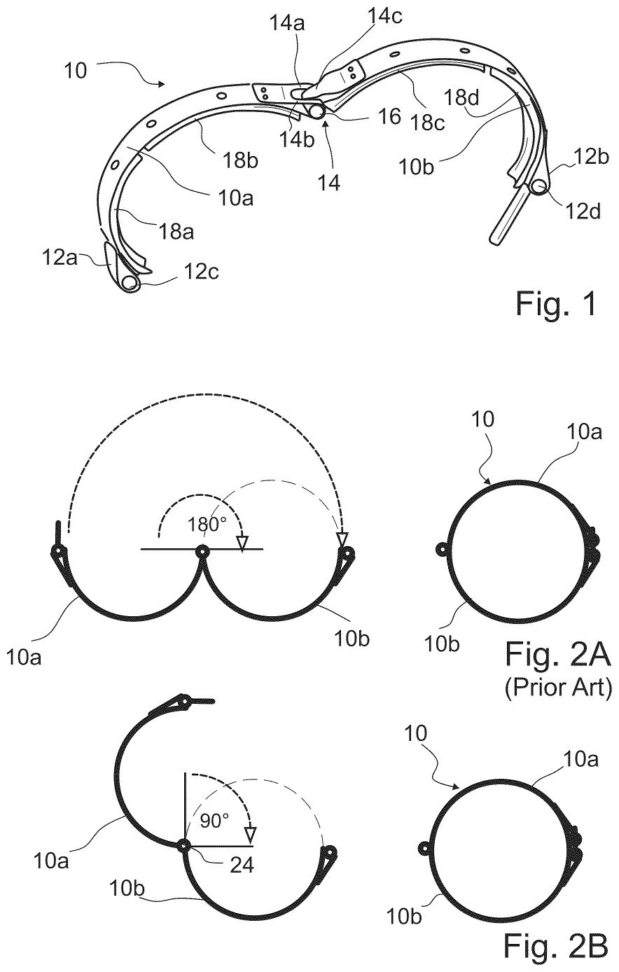

FIG. 1 is a band clamp according to a first embodiment of the invention comprising a clamping band 10, a tensioning element 12 for tensioning the clamping band 10 and a hinge 14 provided at a position opposite to the tensioning element 12. The hinge 14 connects the ends of two essentially semi-circular halves 10a, 10b of the clamping band 10 in a pivotable manner, wherein the hinge 14 includes a trunnion 16 arranged in an axial direction of the clamp.

The tensioning element 12 is formed by two band loops 12a, 12b each receiving a trunnion 12c, 12d with slits for passing and operating a tensioning screw engaging with an inner thread of a bore in one of the trunnions 12c, 12d. Other types of tensioning element, e.g. tensioning elements with a worm screw or with a tensioning lever, could be used in alternative embodiments of the invention.

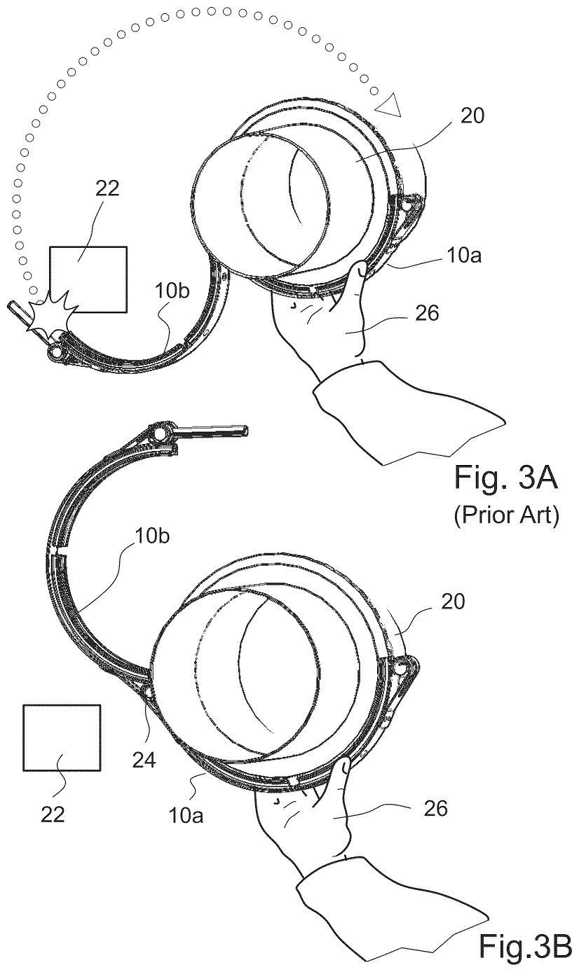

The clamp is formed as a V-clamp and includes four sections each provided with an inlay 18a-18d of generally V-shaped cross-section, respectively. The inlays are arranged radially inside the main, outer clamping band 10. The V-shaped profile of the inlays 18a-18d is configured to interact with flanges formed at mutually facing ends of two pipes 20 (FIG. 3A, FIG. 3B) to be interconnected. The inlays 18a-18d are welded, soldered or clinched to the clamping band 10 and lend a considerable stiffness to the semi-circular sections 10a, 10b thereof.

According to the invention, the ends of the two essentially semi-circular halves 10a, 10b of the clamping band 10 are formed so as to include one flat band loop 14c or two lateral flat band loops 14a, 14b, wherein an inner surface of the lateral flat band loops 14a, 14b bears on a cylindrical outer surface of the trunnion 16. A first one of the semi-circular halves 10a of the clamping band 10 includes two flat band loops 14a, 14b with a gap in between and the second one of the semi-circular halves 110b of the clamping band 10 includes one flat band loop 14c engaging in the gap between the two flat band loops of the first semi-circular half of the clamping band 10. This intermeshing arrangement of band loops 14a-14c makes sure that the tensioning forces act on the trunnion 16 in a manner symmetrical to a circumferential centre line of the clamping band 10 such that the trunnion 16 is not tilted by the tensioning force.

Each of the band loops 12a, 12b, 14a-14c is formed by punching out loop portions on the end of the band 10 and folding the loop portions back onto the band and clinching the respective ends of the loop portions to the main portions of the band, as generally known in the field. The two-pronged loop portions 14a, 14b at one of the band ends are formed as webs sandwiching a longitudinal slit, i.e. are connected at an end portion thereof by a band portion 30 having the full width, i.e. in a portion 30 where the band end is clinched to the main portion of the band 10.

FIG. 2A illustrates a pivoting movement for closing a band clamp with a hinge 14 according to the prior art. The maximum pivot angle of a clamp with a hinge 14 is typically limited by the abutment of the outer surfaces or the semicircular halves 10a, 10b where abut against each other, i.e. roughly 180°. The pivot angle can be measured and/or defined by the angles between tangential lines at the end portion of the two idealized semi-circles of the clamping band 10 in the closed and fully opened configuration of the band clamp.

FIG. 2B illustrates the limited pivot angle of band clamp according to the invention, wherein the hinge 14 of the band clamp is provided with limiting means for limiting the pivot angle to less than 180°, in the case of FIG. 2B to roughly 90°.

FIG. 3A illustrates a typical assembly situation for a generic band clamp with a hinge 14. Use of hinge allows V-Clamp to be opened in very wide range. Such opening can make assembly difficult in environments with limited assembly space, e.g. where an obstacle 22 is arranged in the pivoting range of the clamp. Such conditions may in engine exhaust systems and compressed gas systems, where V-Clamps are applied.

In a first step, the first one of the semi-circular halves 10a is brought in contact with the flanges of the pipes 20 to be connected. To close the clamp, the second one of the semi-circular halves 10b must be pivoted by 180° as illustrated by the arrow in FIG. 2a. The room required for this pivoting movement might not be available in some target applications because obstacles 22 such as other tubes exist. The second one of the halves 10a, 10b must then be threaded into the space between the pipe 20 and the obstacle 22 while at the same time attaching the first one of semi-circular halves 10a to the flanges. This is burdensome and would require using two hands 26, which may not be available in some cases, e.g. where the worker is standing on a ladder or holds a tool.

According to one aspect of the invention, this problem is solved by providing the hinge 14 with limiting means 24 for limiting the pivot angle to less than 180°, in particular to 120° or less.

FIG. 3B illustrates the assembly situation of FIG. 2A when using a band clamp according to the invention including the limiting means 24. Due to the limiting means 24, the second one of the halves 10b can be threaded into the space between the pipe 20 and the obstacle 22 while at the same time attaching the first one of semi-circular halves 10a to the flanges in a simple manner and using only one hand 26. The hinge 14 with the limiting means 24 combines the advantages of improving the transmission of the tensioning force via the hinge 14 while at the same facilitating the mounting of the clamp.

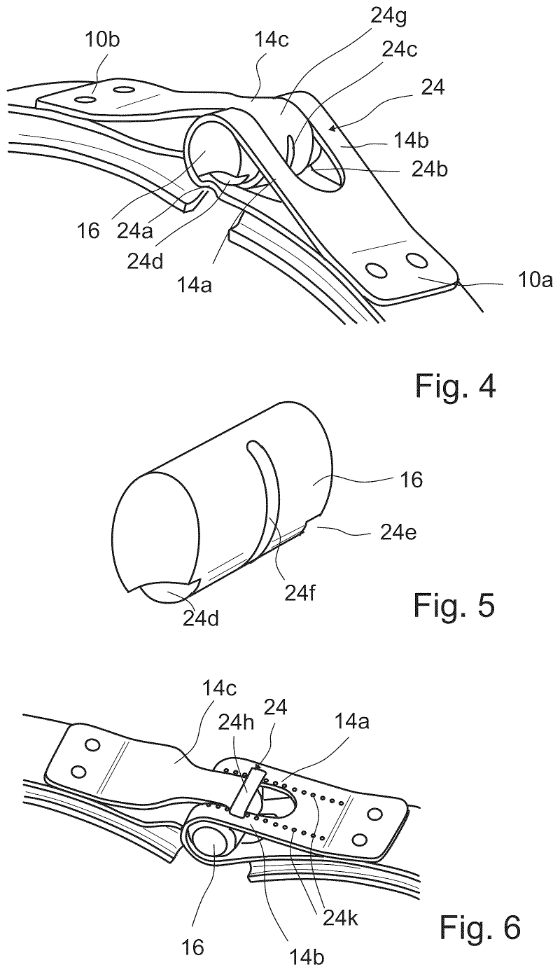

FIG. 4 is a detail view of the hinge 14 of the band clamp according to the invention. FIG. 5 is a detail view of the trunnion 16 of the band clamp according to the invention. The limiting means 24 in this embodiment is formed by protrusions 24a, 24b, 24c on an inner surface of the lateral flat band loops 14a, 14b engaging with a recess 24d, 24e, 24f on the cylindrical outer surface 24g of the trunnion 16, respectively, wherein a circumferential length of the recesses 24d-24f is configured to limit the pivot angle.

Specifically, the axially outer edges of the two lateral flat band loops 14a, 14b of the first one of the semi-circular halves 10a are provided with embossed first protrusions 24a, 24b engaging with first recesses 24d, 24e on the axial edges of the trunnion 16. The first protrusions 24a, 24b engaging with the first recesses 24d, 24e act as “trunnion keepers”, i.e. prevent the trunnion 16 from axially slipping out of the lateral flat band loops 14a, 14b. The first protrusions 24a, 24b may have the same length in the circumferential direction as the first recesses 24d, 24e or be shorter. In the latter case, the first protrusions 24a, 24b may slide within the first recesses 24d, 24e when the hinge 14 is pivoted over a certain angle until the first protrusions 24a, 24b abut to one end of the first recesses 24d, 24e in the longitudinal direction of the first recesses 24d, 24e, respectively.

A slit-like second recess 24f (FIG. 5) is provided in the axial centre of the cylindrical outer surface 24g of the trunnion 16 and is oriented in a circumferential direction of the essentially cylindrical body of the trunnion 16. A corresponding embossed second protrusion 24c (visible only from the backside of the band in FIG. 4) engaging with the slit-like second recess 24f is provided on the inner surface of the central flat-band loop 14c at the end of the second one of the semi-circular halves 10b. The second protrusion 24c slides within the slit-like second recess 24f when the hinge 14 is pivoted over a certain angle until the second protrusion 24c abuts to one end of the slit-like second recess 24f in the longitudinal direction of the second recess 24f. The sum of the maximum sliding angles of the first recesses 24d, 24e and the second recess 24f defines the maximum pivot angle of the hinge 14.

FIG. 6 is a band clamp according to a second embodiment of the invention, wherein the limiting means 24 is formed by a web 24h connecting the two lateral flat band loops 14a, 14b of the first one of the semi-circular halves 10a of the clamp. The central flat band loop 14c of the second one of the semi-circular halves 10b of the clamp abuts upon the web 24h upon reaching the limit value of the pivot angle.

The two lateral flat band loops 14a, 14b of the first one of the semi-circular halves 10a, 10b of the clamp are each provided with a series of bore holes 24k and the web 24h is formed as a clip with legs which can be inserted into one of the bore holes 24k, respectively. By selecting the pair or group of holes 24k into which the web 24h is mounted, the position of the web 24h is adjustable to thereby adjust the limit value of the pivot angle.

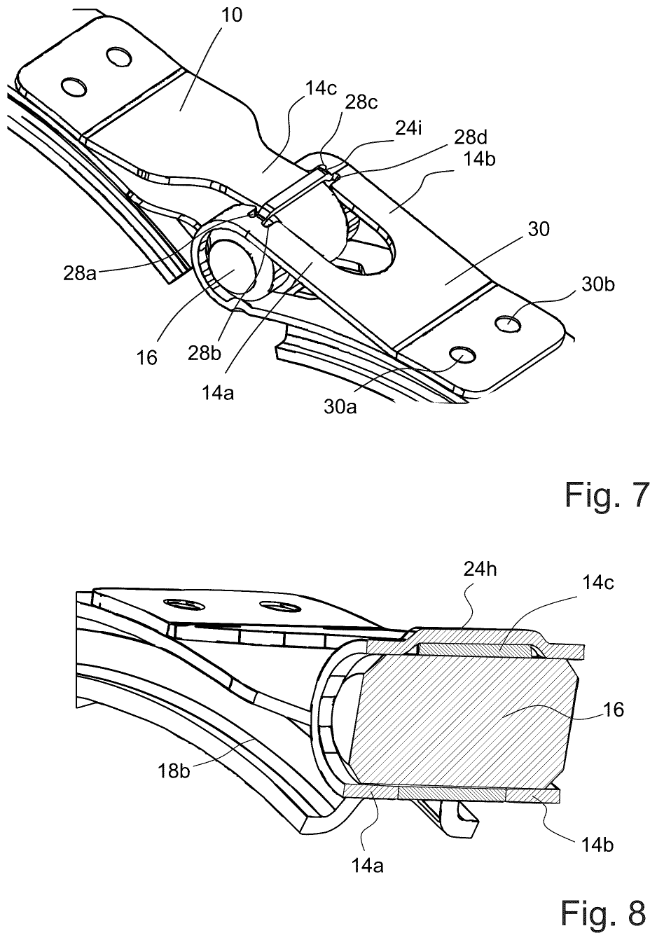

FIG. 7 is a band clamp according to a third embodiment the invention with a fixed web 24i and FIG. 8 is a sectional view of a hinge 14 of the third embodiment of the invention.

While the web 24h of the second embodiment is an additional element fixed on the band loops 14a, 14b, the web 24i is formed by cutting and folding a bride between the band loops 14a and 14b, keeping the same principles of design as for web.

The web 24i is punched out of the sheet metal strip of the band and press-formed so as to protrude over the main level of the lateral flat band loops 14a, 14b by an amount corresponding to the thickness of the central flat band loop 14c. Bay-shaped dents 28a-28d are formed on the laterally inner edges of the lateral flat band loops 14a, 14b on both sides of the end portions of the web 28i, wherein the portions of the web 24i sandwiched between one pair of dents 28a, 28b; 28c, 28d is inclined such that the height of the web 24i is constant over the width of the central flat band loop 14c.

The web 24i acts as a stopper for abutment of the central flat band loop 14c, wherein position of the web 24i along the trajectory of the outer surface of the central flat band loop 14c defines the maximum opening angle. This position, and hence the maximum opening angle, can be easily varied in the course of the manufacturing process by adjusting the points 30a, 30b at which the band portion 30 is clinched to the main portion of the band 10. By moving the points 30a, 30b in the direction of the arrow A, the web 24i will move in the same direction and the maximum opening angle is increased. It is therefore possible to manufacture band clamps with different maximum opening angles using the same punching tool and the same blanks by merely setting the clinching points 30a, 30b in an appropriate manner.

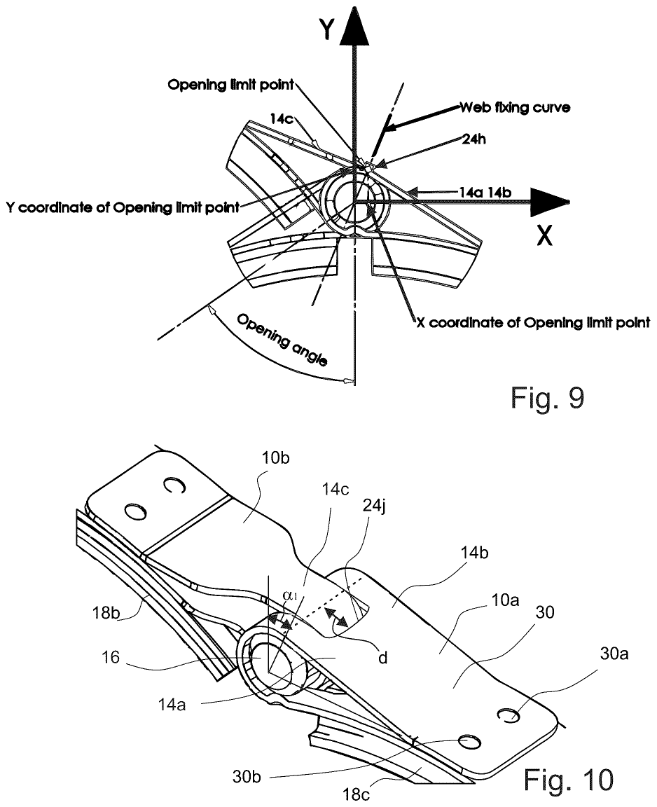

FIG. 9 is a schematic illustration showing limit angles of the hinge of the third embodiment of the invention. Although the following considerations regarding the limit angles are described for the 3^{rd} embodiment, the same considerations apply, mutatis mutandis, for the 2^{nd} and 4^{th} embodiment of the invention. The opening angle is defined as angle between a line Y passing a centre point of the hinge 14 and a middle point of a line which centre points of the trunnions 12c, 12d that are connected by a screw in assembled condition and same line referred to as Y′ in the opened condition in FIG. 9.

The Y axis of coordinate system is defined based on a line passing hinge centre point and middle point of a line which connects the centre points of the trunnions 12c, 12d in the assembled condition. The X axis is perpendicular to Y axis and passes hinge centre point.

In FIG. 9, the band loop angle is an angle between X axis and the central band loop 14c line.

To ensure required opening angle it is necessary to provide elements blocking the possibility of further opening. The position of block depends on the geometry and the desired opening angle. An approximate equation of the curve where the web 24h or 24i has to be fixed is as follows:

$$y = tan ( Band loop angle [ ° ] - 90 [ ° ] - Opening angle [ ° ] ) \cdot x$$

In the case of a specific geometry with known Band loop outside diameter, the coordinates can be determined using equations:

$$X = \frac{Outside loop diameter}{2} \cdot cos ( Loop angle [ ° ] - 90 [ ° ] - Opening angle [ ° ] )$$

$$Y = \frac{Outside loop diameter}{2} \cdot sin ( Loop angle [ ° ] - 90 [ ° ] - Opening angle [ ° ] )$$

The above equations can be solved for X, Y to find an appropriate position X, Y for the web 24h, 24i for any given opening angle.

FIG. 10 is a band clamp according to a fourth embodiment the invention with a fixed web with a limiting means constituted by a rear edge 24j of the slit-shaped gap between the flat band loops 14a, 14b, wherein the rear edge 24j of the gap is positioned to abut to the at least one flat band loop 14c of second one of the semi-circular halves 10b in the fully opened configuration to form the limiting means. To be clear, the rear edge 24j of the gap is constituted by the front end of the band portion 30. Again, the limit opening angle can be set by choosing the clinching points 30a, 30b in an appropriate manner.

### REFERENCE NUMBERS

10 clamping band
10a first half
10b second half
12 tensioning element
12a band loop
12b band loop
12c trunnion
12d trunnion
14 hinge
14a, 14b, 14c band loop
16 trunnion
18a-18d inlay
20 pipe
22 obstacle
24 limiting means
24a protrusion
24b protrusion
24c protrusion
24d recess
24e recess
24f recess
24g cylindrical outer surface
24h web
24i web
26 hand
28a-28i
30 band portion

1. A clamp comprising a clamping band (10), a tensioning element (12) for tensioning the clamping band (10) and a hinge (14) provided at a position opposite to the tensioning element (12), wherein the hinge (14) connects the ends of two essentially semi-circular halves (10a, 10b) of the clamping band (10) in a pivotable manner, wherein the hinge (14) includes a trunnion (16) arranged in an axial direction of the clamp, wherein the ends of the two essentially semi-circular halves (10a, 10b) of the clamp are formed so as to include at least one flat band loop (14a, 14b, 14c), respectively, wherein an inner surface of the flat band loops (14a, 14b, 14c) bears on a cylindrical outer surface (24g) of the trunnion (16).

2. The clamp according to claim 1, including at least one section provided with an inlay (18a-18d) of a V-shape cross-section configured to interact with flanges formed at mutually facing ends of two pipes (20) to be interconnected.

3. The clamp according to claim 1, wherein the hinge (14) includes limiting means (24) for limiting the pivot angle to less than 180°.

4. The clamp according to claim 3, wherein the limiting means (24) is configured to limit the pivot angle to less than 120°.

5. The clamp according to claim 1, wherein the limiting means (24) is configured to limit the pivot angle to 100° or less.

6. The clamp according to claim 1, wherein the limiting means (24) is formed by at least one protrusion (24a-24c) on an inner surface of the flat band loops (14a-14c) engaging with a recess (24d-24f) on the cylindrical outer surface (24g) of the trunnion (16), wherein a circumferential length of the recess (24d-24f) is configured to limit the pivot angle.

7. The clamp according to claim 6, wherein each of the flat band loops (14a-14c) includes a protrusion (24a-24c) engaging with a corresponding recess (24d-24f) on the cylindrical outer surface (24g) of the trunnion (16).

8. The clamp according to claim 1, wherein a first one of the semi-circular halves (10a) of the clamp includes two lateral flat band loops (14a-14b) with a gap in between and the second one of the semi-circular halves (10b) of the clamp includes at least one central flat band loop (14c) engaging in the gap between the two flat band loops (14a, 14b) of the first semi-circular half (10a) of the clamp.

9. The clamp according to claim 8, wherein the two flat band loops (14a-14b) are connected by a band portion forming a rear edge (24j) of the gap, wherein the rear edge (24j) of the gap is positioned to abut to the at least one central flat band loop (14c) of second one of the semi-circular halves (10b) to form said limiting means (24).

10. The clamp according to claim 9, wherein each of the two flat band loops (14a-14b) includes a contact portion in contact with the outer surface of the trunnion and shaped as a circular arc with an angular length 180°+α1, a radius r and a straight upper portion folded back and connected to a main portion of the first one of the semi-circular halves (10a), wherein the rear edge (24j) is positioned at a distance d from a transition point between the contact portion and the straight upper portion, wherein the distance d is smaller than r/tan(α1), preferably smaller than 0.8*r/tan(α1).

11. The clamp according to claim 3, wherein the limiting means (24) is formed by a web (24h) connecting the two lateral flat band loops (14a, 14b) of the first one of the semi-circular halves (10a) of the clamp, wherein the central flat band loop (14c) of the second one of the semi-circular halves (10b) of the clamp abuts upon the web (24h) upon reaching the limit value of the pivot angle.

12. The clamp according to claim 6, wherein a shape and/or position of the web (24h) is adjustable to thereby adjust the limit value of the pivot angle.
